(19) United States
(12) Patent Application Publication
(10) Pub. No.: US 2005/0179277 A1
(43) Pub. Date: Aug. 18, 2005

(54) Slide-out mechanism for use in a vehicle

(76) Inventors: Robert Schneider, Beaver Dam, WI (US); Carl Yoder, Millersburg, IN (US)

Correspondence Address: DARBY & DARBY P.C., P. O. BOX 5257, NEW YORK, NY, 10150-5257, US

(21) Appl. No.: 10/988,430

(22) Filed: Nov. 12, 2004

Related U.S. Application Data
(60) Provisional application No. 60/520,241, filed on Nov. 14, 2003.

(51) Int. Cl. B60P 3/34

(52) U.S. Cl. 296/26.01

(57) ABSTRACT

A slide-out mechanism for a vehicle is provided to extend a slide-out section of a vehicle such as a motorhome, fifth-wheel RV, utility vehicle, etc. The slide-out section is dropped after being driven outward from the vehicle over a predetermined distance. The slide-out mechanism is provided to expand the slide-out section outward in a level manner, i.e., without tilting or angling the slide-out section, and to drop the inside and outside ends of the slide-out section at approximately the same time, thereby enabling the slide-out section to expand outwards to its fullest extent and to attain a flush alignment between the floors of the stationary main floor and the moveable slide-out section floor.

### CROSS-REFERENCE TO RELATED APPLICATION

The present application claims the benefit of U.S. patent application Ser. No. 60/520,241, filed Nov. 14, 2003, and is related to U.S. patent application Ser. No. 10/______, filed concurrently herewith and entitled “SINGLE OR DUAL FLUSH FLOOR UPPER DECK SLIDE-OUT”, which claims the benefit of U.S. patent application Ser. No. 60/519,976, all of which are hereby incorporated by reference in their entirety.

### TECHNICAL FIELD

The present invention relates to vehicles with moveable room sections, and more particularly, relates to a slide-out mechanism that moves the moveable room section in a controlled manner from a retracted position relative to a main housing of the vehicle to an extended position where the moveable room protrudes beyond the main housing.

### BACKGROUND

Conventional recreational vehicles (RV) are available in a number of different types depending upon the size requirements and other desires of the purchaser. For example, the purchaser or user can select an RV that is motorized and can be driven by itself or one can be selected that requires a tow vehicle to tow the RV. Consumers increasingly want additional, increased interior room and also want to be provided with additional options available with the RV. One option that has found increasing commonality in the recent years is the incorporation of one or more slide-out sections into the RV. The slide-out sections are part of an automated system where the user simply activates the system resulting in the slide-out section extending outward from an exterior wall of the RV. The slide-out section in its extended position thus increases the overall available interior space. Slide-out sections can be incorporated into any number of different types of RVs including motor homes and fifth wheel trailer type RVs.

With respect to a fifth wheel type RV, the upper deck portion is typically used as a living area and therefore, the incorporation of a slide-out section in the upper deck portion is desirable since it results in an increase in the available space for use as a living area. However, it is difficult to incorporate conventional slide-out mechanisms into the upper deck of a fifth wheel trailer. In conventional recreational vehicles, the operating mechanism is stored in the front or rear section of the slide-out mechanism. However, in the case of a slide-out mechanism in the upper deck, the operating mechanism would be blocked by the fifth wheel if the slide-out mechanism was placed in front. Access to the operating mechanism would be difficult since it would be necessary to remove the fifth wheel to access the operating mechanism. Thus, these constraints make it difficult for the slide-out mechanism to be incorporated into the fifth wheel section.

In conventional recreational vehicles, the slide-out mechanism is many times incorporated above the floor of the vehicle since it is difficult to integrate the slide-out mechanism into the chassis. It is also difficult to integrate the slide-out mechanism into the chassis in a way that maintains a pleasing appearance for the vehicle. As a result, the slide-out mechanism is typically placed above the floor location; however, by incorporating the slide-out mechanism above the floor of the upper deck, the amount of available interior space in the upper deck decreases and thus, it is somewhat counterproductive to place the mechanism at this location.

Conventional recreational vehicles typically include slide-out mechanisms with one or two arms that are the drive means for driving the slide-out section. However, slide-out mechanisms including only one arm provide limited support and are less stable. For slide-out mechanisms including multiple arms, the movement of the arms must be synchronized. Arms that are not synchronized cause the slide-out section to be misaligned during expansion which can damage the slide-out mechanism and spoil the outward appearance of the vehicle.

A conventional recreational vehicle with a slide-out mechanism also typically includes a main floor section and a moveable floor section. In the retracted position, the moveable floor sections lie on top of the main floor section. In the extended position, the moveable floor sections slide outward with respect to the main floor section. However, the height differential between the moveable floor sections and the main floor sections creates a step that is a potential safety hazard and detracts from the appearance of the room.

Conventional recreational vehicles with slide-out mechanisms typically include a slide-out mechanisms that slides the moveable floor section at an angle as the slide-out section is extended away from the vehicle. Therefore, in the extended position, the moveable floor section has gradually dropped to create a “flush floor” with the main floor section. However, sliding the moveable floor section at an angle causes the slide-out room to tilt until it is level at the extended or retracted positions.

### SUMMARY

Thus, it is one object of the present invention to provide a slide-out mechanism for the upper deck that is integrated into the chassis, has excellent structural integrity, and has at least three arms that are synchronized when the mechanism is actuated and the arms are extended. The slide-out mechanism also provides an aesthetically attractive appearance in its extended and retracted positions. Another object of the present invention is to provide a slide-out mechanism with a moveable room section whose floor is aligned flush with the floor of the stationary room section without causing the slide-out room to tilt as it moves between the retracted and extended positions.

The aforementioned objects are achieved by providing a slide-out mechanism for a vehicle to extend and retract at least one slide-out section relative to a frame of the vehicle. The slide-out section has a floor and is configured for incorporation into a chassis of the vehicle and includes (a) a frame; (b) a plurality of movable arms supported by the frame and having ends that are securely coupled to the floor of the slide-out section, wherein at least one of the movable arms is a drive arm; and (c) drive means coupled to an intermediate section of the drive arm for driving the drive arm in a first direction for extending the movable arm outwardly from the frame resulting in the slide-out section being driven to an extended position and a second direction for retracting the movable arm toward the frame resulting in the slide-out section being driven to a retracted position.

It will be appreciated that the present slide-out mechanism can be incorporated into a chassis associated with any number of different types of vehicles, such as motor homes or a trailer type vehicle.

In one embodiment, a fifth wheel type recreational vehicle is provided and including a main cabin portion and an upper deck portion having a chassis that supports a stationary base floor and a slide-out section that includes a floor and selectively extends from an exterior surface when actuated for increasing an interior space of the upper deck portion. The vehicle includes a slide-out mechanism for selectively moving the slide-out section between a retracted position and an extended position, with the mechanism being nested within receiving features that are formed in the chassis so as to couple the mechanism to the chassis. The mechanism is disposed underneath the stationary base floor and includes: (a) a frame that is securely attached to the chassis; (b) at least three hollow support members that have first ends that are securely coupled to the frame and second ends that are nested within the receiving features of the chassis, with at least one of the hollow support members having an elongated slot formed in a face thereof; (c) at least three arms that are slidably received within the hollow support members with each having one end thereof that is securely connected to the overlying floor of the slide-out section such that movement of the arm is translated into movement of the arms is translated into movement of the floor of the slide-out section, wherein at least of the arms is a drive arm; (d) a drive device that is selectively operable and includes an elongated drive piston that extends through the elongated slot and is coupled at one end to a medial region of the drive arm; wherein extension of the drive piston is translated into extension of the drive arm outwardly beyond the chassis resulting in the slide-out section moving from a retracted position where it overlies the stationary floor to an extended position where the floor of the slide-out section is substantially flush with the stationary floor and when the drive piston is retracted, the drive arm is likewise retracted causing the slide-out section to be drawn back to the retracted position; and (e) a ramp structure that cooperates with the stationary floor and is coupled to the chassis to permit the floor of the slide-out section to ride down the ramp structure as the floor is moved from the retracted position to the extended position and vice versa when the floor is driven back to the retracted position.

### BRIEF DESCRIPTION OF THE DRAWINGS

The foregoing and other features of the present invention will be more readily apparent from the following detailed description and drawings of the illustrative embodiments of the invention wherein like reference numbers refer to similar elements and in which:

FIG. 1 is a perspective view of a fifth wheel RV with slide-out section in the upper deck according to an embodiment of the present invention;

FIG. 2 is an exploded perspective view of an upper deck portion of a chassis and a slide-out mechanism according to an embodiment of the present invention;

FIG. 3 is a perspective view of a slide-out mechanism mounted onto an upper deck portion of the chassis according to an embodiment of the present invention;

FIG. 4 is a cutaway view taken along line 4 of FIG. 2 showing the connection between a stub on a side frame member and a rear support member;

FIG. 5 is a cutaway view taken along line 5 of FIG. 2 showing wear tabs positioned on a rear support member;

FIG. 6 is a cutaway view taken along line 6-6 of FIG. 2 of a middle telescoping arm in the retracted position inside a middle support member;

FIG. 7 is a side view of a middle telescoping arm moving to the extended position inside a middle support member;

FIG. 8 is a perspective view of the interior space of a fifth wheel RV when a slide-out section is in the retracted position;

FIG. 9 is a perspective view of the interior space of a fifth wheel RV when a slide-out section is in the extended position;

FIG. 10 is a cutaway view taken along the line 10-10 of FIG. 8 of a moveable floor when a slide-out section is in the retracted position;

FIG. 11 is a cutaway view taken along the line 11-11 of FIG. 9 of a moveable floor when a slide-out section is in the extended position;

FIG. 12 is a perspective view of a center support sub-assembly of an alternate embodiment of the present invention;

FIG. 13 is a perspective view of a passive support sub-assembly of an alternate embodiment of the present invention;

FIG. 14 is a perspective view of a center support sub-assembly and a rack-and-pinion mechanism of an alternate embodiment of the present invention;

FIG. 15 is a perspective view of a gear mechanism of the rack-and-pinion mechanism of FIG. 14;

FIG. 16 is a cutaway side view of the center support sub-assembly and the rack-and-pinion mechanism of FIG. 14;

FIG. 17 is a side view of a middle arm and middle support member of the center support sub-assembly of FIGS. 15 and 16;

FIG. 18 is a local perspective view of a slide-out mechanism according to another embodiment shown in combination with a vehicle frame;

FIG. 19 is a cross-sectional view taken along the line 19-19 of FIG. 18 showing a movable arm supported by a roller assembly that assists in dropping the arm into a flush arrangement with a floor of the vehicle;

FIG. 20 is a local exploded perspective view of the roller assembly taken at arrow 20 of FIG. 18;

FIG. 21 is a side elevation view of the slide-out mechanism of FIG. 18 with the movable arm in a retracted position;

FIG. 22 is an elevational cross-sectional view taken along the line 22-22 of FIG. 18 showing a ramp of the movable arm;

FIG. 23 is a perspective view of the movable arm;

FIG. 24 is a detailed perspective view taken at arrow 24 of FIG. 24 illustrating a rear roller assembly;

FIG. 25 is a side elevation view of the slide-out mechanism of FIG. 18 with the movable arm in the extended position; and

FIG. 26 is a cross-sectional view taken along the line 19-19 of FIG. 18 showing the movable arm supported by the roller assembly.

### DETAILED DESCRIPTION OF THE EMBODIMENTS

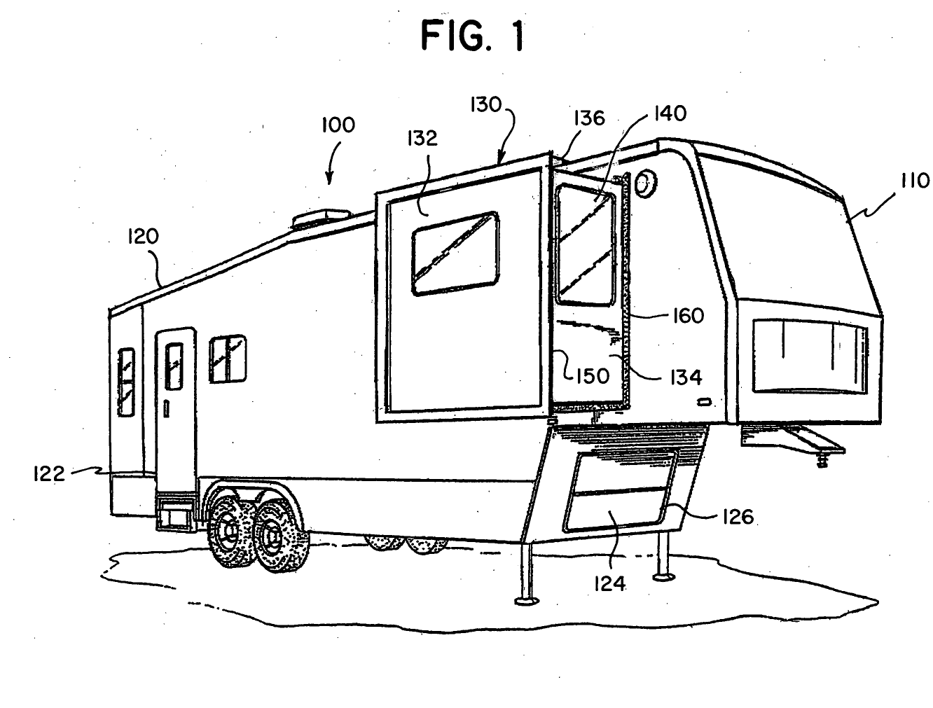

FIG. 1 is a perspective view of one exemplary recreational vehicle (RV) 100. There are a number of different type of RVs that are available to a user depending upon a particular individual's needs, desires and wishes. For example, one type of RV is a motor home that is a self-contained motorized RV that looks something like a bus and is often referred to as a “coach”. This type of RV includes a number of different rooms and amenities that can provide superior comfort. Another type of RV is a travel trailer that is designed to be towed by a vehicle having hitch equipment for securely mating with the frame of the tow vehicle. Yet another type of RV is called a fifth wheel trailer (often referred to as a “fifth wheel”) which is a trailer that is designed to be towed by a vehicle, such as a pickup truck, that is equipped with a special hitch in a bed portion of the tow vehicle. FIG. 1 illustrates a fifth wheel type RV 100; however, it will be understood that the present invention is not limited to fifth wheel type RVs but rather it can be incorporated into other types of RVs, including those mentioned above. The fifth wheel type RV 100 is easily distinguished by its neck portion 110, which is also called an upper deck portion of the RV 100, that is formed at the front of the RV 100. Often times, this upper deck portion 110 houses a living room. To the rear of the upper deck portion 110, a main cabin or housing 120 is provided and extends completely to the rear of the RV 100 and typically includes additional rooms, such as a master bedroom, kitchen, bathroom, etc. A door 122 for entering the interior of the main cabin 120 is provided in this section.

In most, if not all, of the RVs mentioned above, one or more slide-out sections 130 can be provided which, when extended, provide an increased amount of interior space. For example, the exemplary fifth wheel RV 100 of FIG. 1 has at least one and preferably two slide-out sections 130 which are controllably movable from a retracted position to an extended position (shown in FIG. 1) for the purpose of increasing the available interior space of the RV 100. By actuating a slide-out mechanism, described in greater detail hereinafter, one or more sections of an exterior wall 132 of the RV can be extended away from the surrounding exterior wall. As shown in FIG. 1, the slide-out section 130 contains not only the exterior wall section 132 but also has a pair of side walls 134 as well as a roof section 136. One or more windows 140 can be incorporated into the slide-out section 130 as well. In order to provide a seal against the elements in both the retracted and extended positions, a skirt 150 can be provided around the exterior wall section 132 and a seal element 160 can be provided around the opening formed in the surrounding exterior wall that permits the extension and retraction of the slide-out section 130. When the slide-out section 130 is retracted, the skirt 150 preferably is in intimate contact with the seal element 160 to effectively seal the interior of the RV 100. The seal element 160 can be formed of any number of conventional sealing materials, such as a suitable insulation, etc. In addition, another seal element (not shown) can be provided on an underside of the skirt 150.

Below the upper deck portion 110 toward the front of the RV 100, a storage compartment 124 can be provided. The interior of the storage compartment 124 can be accessed via a door 126 provided at the front or on one or both of the sides of the storage compartment 124.

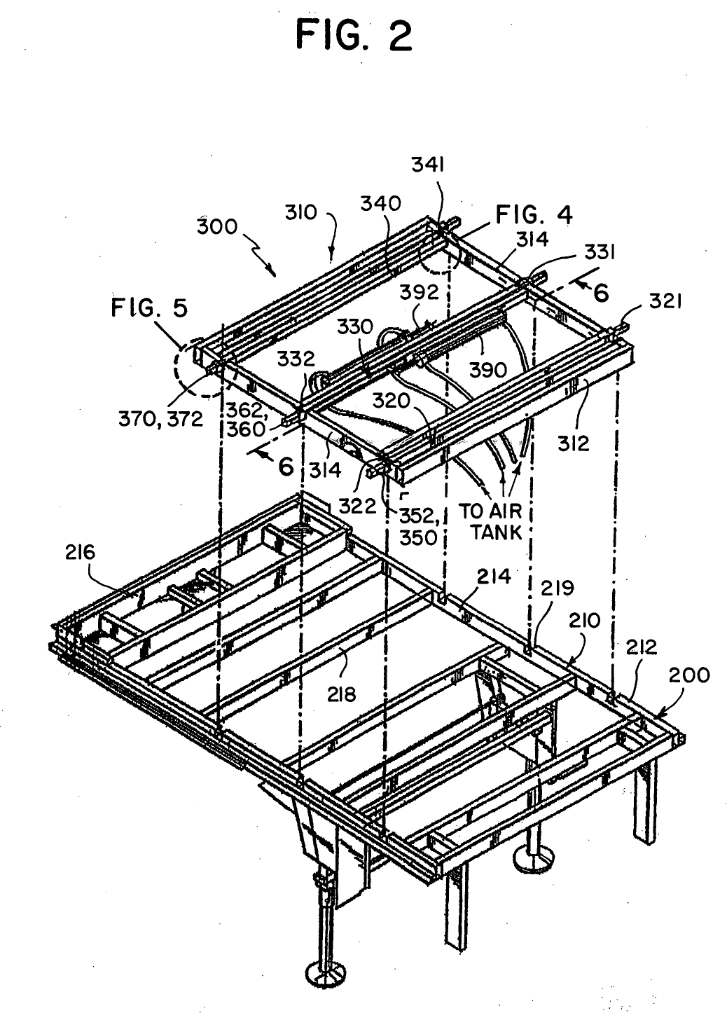

As shown in FIG. 2, the RV 100 includes a structural frame in the form of a chassis 200 that supports the upper deck portion 110 and the main cabin 120. The chassis 200 includes an upper deck portion 210 and a main cabin portion (not shown). The upper deck portion 210 of the chassis 200 supports the upper deck portion 110 of the RV 100.

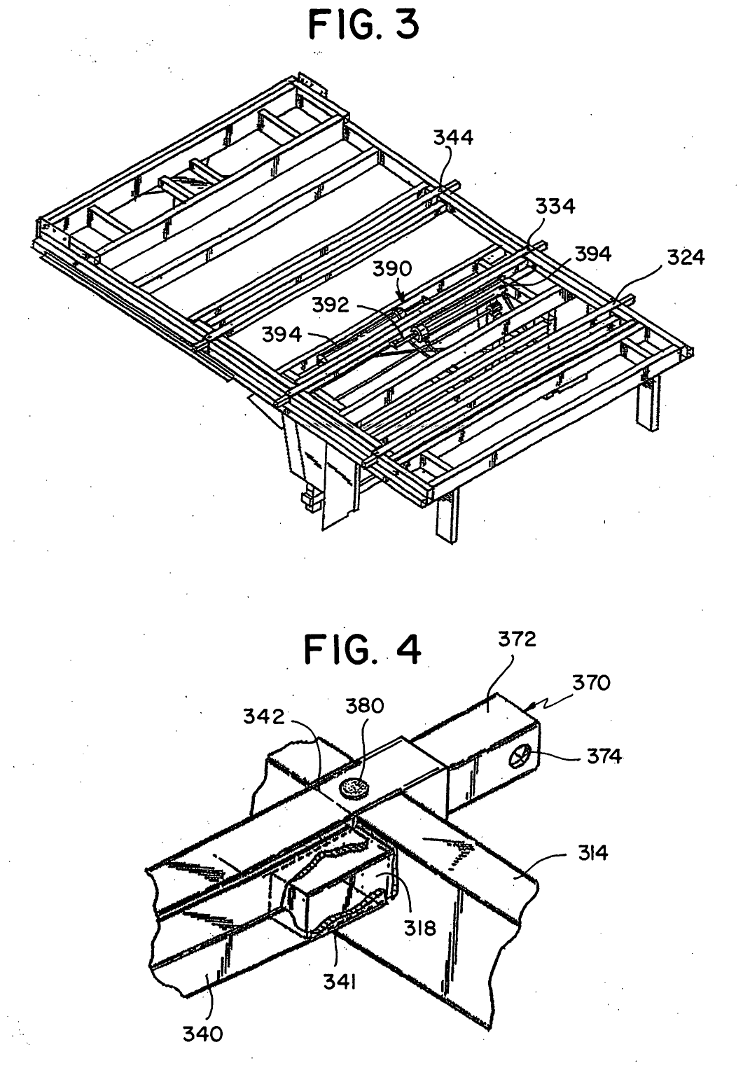

FIG. 2 is an exploded perspective view of a slide-out mechanism 300 which is mounted onto and incorporated into the upper deck portion 210 of the chassis 200, and FIG. 3 is a perspective view of the slide-out mechanism 300 mounted onto the upper deck portion 210 of the chassis 200 according to an embodiment of the present invention. The slide-out mechanism 300 helps to enable the slide-out section 130 of the RV 100 to move between the retracted position and the extended position shown in FIG. 1. The slide-out mechanism 300 of the present invention, however, is not limited to being placed in the upper deck portion 210 of the chassis 200 and can be used in combination with slide-out sections 130 in other areas of the RV 100, such as in the main cabin 120. The upper deck portion 210 of the chassis 200 is constructed in a conventional manner in that it includes a plurality of structural support members 212 that are arranged and coupled to one another to provide a support platform for the upper deck portion 110 of the RV 100. For example, the upper deck portion 210 can include side frame members 214 that are spaced apart from one another; end frame members 216; and a plurality of cross support member 218 that are securely coupled at their ends to the side frame members 214. Each of the side frame members 214 includes a plurality of spaced notches 219 formed therein at pre-selected locations. The function of the notches 219 will be described hereinafter. The notches 219 can be formed to have any number of shapes and according to the illustrated embodiment, the notches 219 are U or C-shaped in construction. The number of notches 219 will vary on the construction of the slide-out mechanism 300 and in one exemplary embodiment (as illustrated), there are three notches 219 in each of the side frame members 214 with one notch 219 being axially aligned with one corresponding notch 219 on the other side frame member 214. The frame members of the chassis 200 are typically metal support beams that can be solid or hollow in construction.

The slide-out mechanism 300 functions as a mechanical drive mechanism for causing the controlled extension and retraction of the slide-out sections 130. The slide-out mechanism 300 can be configured to drive a single slide-out section 130 or it can be configured to drive two slide-out sections 130 as in the illustrated embodiment, and thus can be referred to as a dual slide-out drive mechanism.

The slide-out mechanism 300 includes a base frame 310 is complementary to the upper deck portion 210 of the chassis 200 so that the base frame 310 can be mated therewith, resulting in the frame 310 being supported by the upper deck portion 210. The base frame 310 is securely attached to the upper deck portion 210 of the chassis 200 using conventional techniques, such as a welding process where the interfaces between the two are securely welded to one another. In other words, welds are formed, for example, between the surfaces of the chassis 200 (upper deck portion 210) and the frame 310 which are in contact.

The exemplary frame 310 has a square shape (box) or can be rectangular shaped and is formed of a front frame member 312, two side frame members 314, and a rear frame member 316. The frame members 312, 314, 316 are connected at their ends to each other so as to form a rigid support frame and typically, the frame members 312, 314, 316 are formed of metal materials and can either be solid or hollow in construction. In the illustrated embodiment, each of the frame members 312, 314, 316 is a hollow member with a substantially rectangular cross-sectional shape and therefore, can be thought of as tubular support member. It will be appreciated that the frame members 312, 314, 316 can be formed in any number of different shapes so long as the members 312, 314, 316 are compatible with the upper deck portion 210 of the frame 200.

The frame 310 further includes a plurality of cross support members, namely, two front support members 320, two middle support members 330, and two rear support members 340. Each front support member 320 includes a first end 321 and a second end 322; the middle support member 330 includes a first end 331 and a second end 332; and the rear support member 340 includes a first end 341 and a second end 342. The support members 320, 330, 340 are very similar, if not identical, to one another and they have substantially identical outer dimensions and lie parallel to each other when they are coupled to the side frame members 314.

The two front support members 320 are positioned proximate to each other toward the front frame member 312 at the front of the frame 310, and the two rear support members 340 are positioned proximate to each other toward the rear frame member 316 at the rear of the frame 310. The front support members 320 are preferably substantially identical to the rear support members 340. The middle support members 330 are coupled to one another and are positioned side-by-side near the middle of the frame 310.

The support members 320, 330, 340 are generally hollow members that receive a plurality of telescoping arms 350, 360, 370, respectively, as described below. The first ends 321, 331, 341 of the support members 320, 330, 340 are slidably connected to one of the side frame members 314 such that while the first ends 321, 331, 341 are securely coupled thereto, the support members 320, 330, 340 are permitted a limited degree of travel. For example, an inner surface of the side members 314 can include a plurality of spaced protrusions, posts or stubs 318 that are received with the first ends 321, 331, 341. The protrusions 318 thus have a complementary shape and are dimensioned so that they can be received within the support members 320, 330, 340. Thus, the illustrated protrusions 318 have a generally rectangular or square cross-section.

The plurality of telescoping arms 350, 360, 370 are mounted at positions spaced apart along the length of the side frame members 314. Front telescoping arms 350 and rear telescoping arms 370 are slidably supported within the front support members 320 and the rear support members 340, respectively. The front telescoping arms 350 are substantially identical to the rear telescoping arms 370. A middle telescoping arm 360 is slidably supported within the middle support member 330. In an embodiment of the present invention, the frame members 312, 314, 316, the support members 320, 330, 340 and the arms 350, 360, 370 are tubular, as shown in FIGS. 1-11.

The front telescoping arm 350 includes a first end 351 and a second end 352; the middle telescoping arm 360 includes a first end 361 and a second end 362; and the rear telescoping arm 370 includes a first end 371 and a second end 372. The telescoping arms 350, 360, 370 have substantially identical outer dimensions since the inner dimensions of the support members 320, 330, 340 are substantially identical. The first ends 351, 361, 371 of the telescoping arms 350, 360, 370 are free to slide within their respective support members 320, 330, 340. The second ends 352, 362, 372 of the telescoping arms 350, 360, 370 extend beyond the second ends of the support members 320, 330, 340.

The support members 320, 330, 340 and telescoping arms 350, 360, 370 are aligned such that their length in the longitudinal direction is parallel to the direction of expansion or retraction of the slide-out section 130 across the width of the RV 100. The telescoping arms 350, 360, 370 are configured so that three arms 350, 360, 370 are capable of extending telescopically from each of the sides of the frame 310 when the mechanism 300 is actuated as described below.

The second ends 322, 332, 342 of the support members 320, 330, 340 are disposed within the plurality of notches 319 in the frame 310 and the plurality of notches 219 (shown in FIG. 2) in the upper deck portion 210 of the chassis 200 when the slide-out mechanism 300 is securely mounted to the chassis 200. In other words, and as will be described herein, the notches 319 in the frame 310 are substantially aligned with the notches 219 in the chassis 200 when the slide-out mechanism 300 is incorporated into the chassis 200.

The notches 219, 319 are formed in a U-shape and are cut away from the top surface of the side frame members 314 and the upper deck portion 210 of the chassis 200. Each notch 219, 319 has dimensions which are slightly larger than the outer dimensions of the support members 320, 330, 340 to permit a snug fit therebetween. The support members 320, 330, 340 sit and slide inside the notches 219, 319. The notches 219, 319 are positioned so that the support members 320, 330, 340 are aligned with the direction of expansion or retraction of the slide-out section 130 of the RV 100.

FIG. 4 is a cutaway view taken along circle 4 of FIG. 2 showing the connection between the rear support member 340 and the stub 318 on the side frame member 314. The first ends 321, 331, 341 of the support members 320, 330, 340 are slidably coupled to one of the side frame members 314 via the stubs 318. The stub 318 is fastened to the inward-facing vertical surface of the side frame member 314 by a method such as welding or the stub 318 can be formed integral thereto as during a molding process. The stub 318 can be formed solid or tubular.

Each of the side frame members 314 includes two stubs 318 on the inward-facing vertical surface thereof. The stubs 318 are coupled to and aligned with the front support members 320 and rear support members 340. The outer dimensions of the stub 318 are slightly smaller than the inner dimensions of the front support members 320 and rear support members 340 so that the first ends 321, 341 of the front and rear support members 320, 340 fit around the stub 318. This coupling forms a sliding connection that allows the front and rear support members 320, 340 to slide with respect to the stub 318 and the frame 310. This sliding motion is limited by the length of the stub 318. This sliding connection is formed between the first ends 321, 341 of the front and rear support members 320, 340 to the respective side frame members 314 via the stubs 318. Thus, since the front and rear support members 320, 340 are not fixedly attached to the frame 310, the front and rear support members 320, 340 are able to find their equilibrium by sliding freely with respect to the frame 310, thereby increasing the stability of the structure.

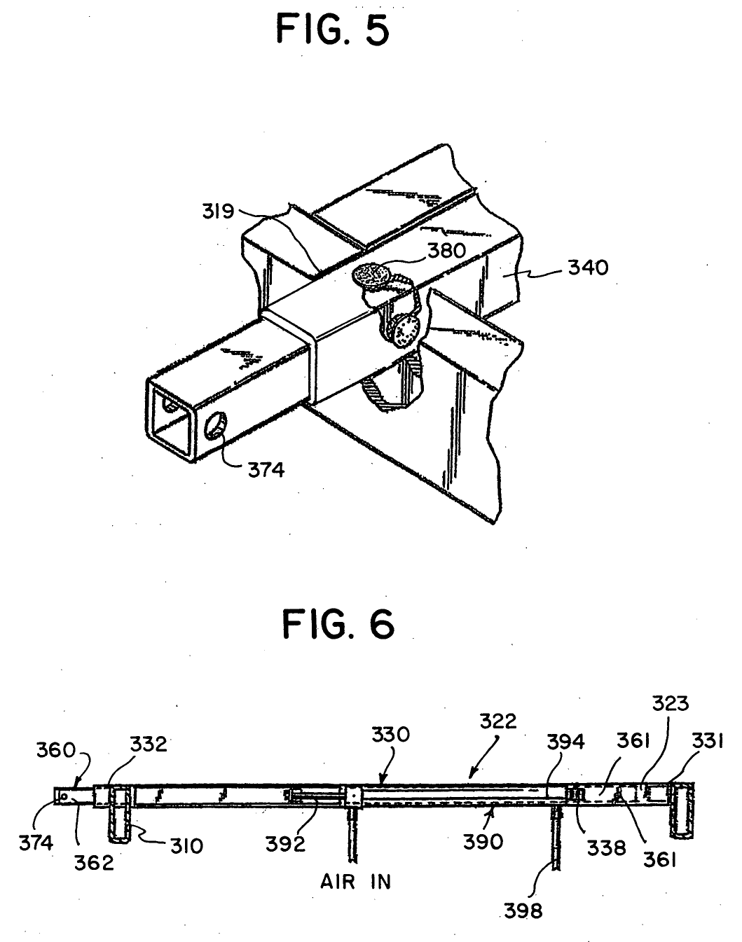

In one embodiment of the present invention, wear tabs 380 are provided on the arms 350, 360, 370 and the support members 320, 330, 340 to facilitate movement of the arms 350, 360, 370 inside the support members 320, 330, 340 and to protect the inside surfaces of the support members 320, 330, 340 and the outside surfaces of the arms 350, 360, 370. FIG. 5 is a cutaway view taken along circle 5 of FIG. 2 showing wear tabs 380 positioned on the rear support member 340.

Openings 324, 334, 344 for fastening the wear tabs 380 are disposed on the top and side surfaces of the respective second ends 322, 332, 342 of the support members 320, 330, 340 that protrude from the frame 310. Wear tabs 380 are also fastened to openings (not shown) provided on the top and side surfaces of the first ends 351, 361, 371 of the arms 350, 360, 370. Therefore, wear tabs 380 are provided on each of the interfaces between the top and side surfaces where the first ends 351, 361, 371 of the arms 350, 360, 370 slide inside the respective support members 320, 330, 340 and where the second ends 322, 332, 342 of the support members 320, 330, 340 support the arms 350, 360, 370 as they slide therein. Each wear tab 380 is positioned to contact the inner surface of the support member 320, 330, 340 and the outer surface of the arm 350, 360, 370. The wear tabs 380 are positioned only on the upper and side interfaces between the arm 350, 360, 370 and the support member 320, 330, 340 to help to protect the opposing surfaces of the support members and arms against damage, such as by scratching or abrasion, to the opposing surfaces of the arm and the support member.

FIG. 6 is a cutaway view taken along line 6-6 of FIG. 2 of one middle telescoping arm 360 in a retracted position inside one middle support member 330. The first end 331 of each middle support member 330 is fixedly supported by one side frame member 314, e.g., by welding, and is slidably supported by the notches 319 on the other side frame member 314 and by the notches 219 in the chassis 200. The two middle support members 330 are attached to each other in the middle of the frame 310 between the front support members 330 and the rear support members 340.

Each of the middle support members 330 includes a vertical surface or face 335 that faces away from the other middle support member 330. Thus, the vertical surface 335 in the middle support member 330 toward the front of the RV 100 faces the front of the RV 100, and the vertical surface 335 in the middle support member 330 toward the rear of the RV 100 faces the rear of the RV 100. A longitudinal slot 336 extends through the vertical surface 335 of the middle support member 330. As will be appreciated, the length of the longitudinal slot 336 defines the distance that the middle telescoping arm 360 can be driven as is described in detail hereinafter. The longer the longitudinal slot 336, the greater the distance that the middle telescoping arm 360 can be driven. The illustrated longitudinal slot 336 is rectangular shaped.

The middle support member 330 supports the middle arm 360 which slides therein, and the second end 362 of the middle arm 360 protrudes beyond the end of the middle support member 330. It is the telescoping arms 350, 360, 370 that support and permit the extension and retraction drive movements of the slide-out section 130.

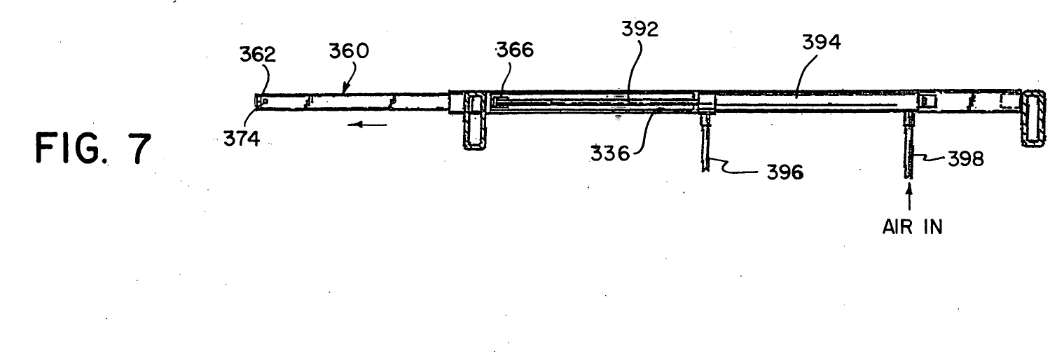

FIG. 6 shows the middle arm 360 in the retracted position, and FIG. 7 shows the middle arm 360 moving to the extended position. It will be appreciated that even when the middle arm 360 is driven to its extended position, a substantial length of the middle arm 360 remains within the middle support member 330. The mechanism 300 includes an operating mechanism 390 (shown in FIGS. 6 and 7) that includes a pair of drive shafts 392 which transfer motion from the operating mechanism 390 to the respective middle arms 360 to cause the extension or retraction of the middle arms 360.

Actuation of the operating mechanism 390 causes movement of the drive shaft 392 and since one end of the drive shaft 392 is coupled to one of the middle arms 360, the driving action is translated to the middle arm 360. The longitudinal slot 336 permits access to the middle arm 360 so that the shaft 392 can be coupled to a medial section of the middle arm 360. The slot 336 in the middle support member 330 allows the shaft 392 and the middle arm 360 to slide with respect to the middle support member 330 as the shaft 392 is driven. More specifically, the length of the slot 336 in the middle support member 330 enables the shaft 392 to access the middle arm 360 while the slide-out section 130 is in the extended or retracted positions. One stroke of the operating mechanism 390 slides the middle arm 360 in and out of the middle support member 330 between a first position shown in FIG. 6 corresponding to the retracted position of the slide-out section 130 of the RV 100 and a second position corresponding to the extended position of the slide-out section 130 of the RV 100.

The operating mechanism 390 can have components that are disposed within the storage compartment 170 of the RV 100, thereby allowing access to the operating mechanism 390 via the door 126 of the storage compartment 124. The storage compartment 390 is located below the frame 310 of the slide-out mechanism 300 in the embodiment of the present invention shown in FIGS. 1-11.

In one embodiment of the present invention as shown in FIGS. 1-11, the operating mechanism 390 is a pneumatic system which uses pneumatic pressure to controllably drive the middle arms 360 in either a first direction to extend the middle arms 360 or an opposite second direction to retract the middle arms 360. In this embodiment, the operating mechanism 390 includes a pair of hydraulic cylinders 394 for driving the shaft 392 in either an extension direction or a retraction direction, thereby allowing the middle arm 360 to slide within the middle support 330.

Each of the hydraulic cylinders 394 is connected to a first conduit 396 and a second conduit 396 for transferring a fluid such as air to and from the hydraulic cylinders 394 to extend and retract the drive shaft 392. For example, as shown in FIG. 6, when air is supplied to the hydraulic cylinder 394 via the first conduit 396, the hydraulic cylinder 394 will move to the retracted position, and as shown in FIG. 7, when air is supplied to the hydraulic cylinder 394 via the second conduit 398, the hydraulic cylinder 394 will move to the extended position.

A bracket, such a right angle/L-shaped bracket, 338 is mounted toward the first end 331 of the middle support member 330. One of the hydraulic cylinders 394 is mounted onto each of the brackets 338 which act to support the cylinder 394 in a manner that permits the working components of the mechanism 300 to freely move. A coupling member 366 is associated with each of the middle arms 360 and acts to couple the shaft 392 to the middle arm 360. In one embodiment, the coupling member 366 is a plate that is mounted onto each middle arm 360 in an intermediate position between the first end 361 and the second end 362 of the middle arm 360. The shaft 392 is coupled to the plate 366 and serves as a piston that slides longitudinally within the hydraulic cylinder 394 and since the shaft 392 and plate 366 are coupled to one another, the movement of the piston is translated into movement of the middle arm 360. The plate 366 is positioned so that it can be accessed through the slot 336 in the middle support member 330 while the slide-out section 130 is in the extended or retracted positions. Thus, the ends of the slot 336 define the degree of travel of the plate 366. Preferably, the pneumatic source (air source) is one of the components that can be disposed within the storage compartment 124.

The hydraulic cylinders 390 are connected to an actuation mechanism (not shown) such as a button or a switch. The user operates the actuation mechanism to extend or retract the slide-out mechanism 300 via the operating mechanism 390. For example, when the slide-out sections 130 are in the retracted position and the user flips the switch, the hydraulic cylinders 394 are actuated and the shafts 392 extend and cause the two middle arms 360 to be driven in opposite directions relative to the frame which corresponds to the middle arms 360 either both being driven to an extended position or being driven to a retracted position. As will be described in greater detail below, the driving of the middle arms 360 is directly translated to movement of the slide-out sections 130 in the same direction that the middle arms 360 are driven. When the user flips the switch back to its original position, the hydraulic cylinders 394 operate in the opposite manner and the shafts 392 retract, thereby retracting the slide-out sections 130.

Alternatively, the operating mechanism 390 can include a rack-and-pinion mechanism, such as the rack-and-pinion mechanism shown in FIGS. 14-17 as described below, to move the middle arms 360 between the extended and retracted positions, instead of the hydraulic cylinders 394.

It will also be appreciated that another mechanism, such as a stepper motor, may be used to controllably extend and retract the shafts 392 to cause the controlled movement of the slide-out sections 130.

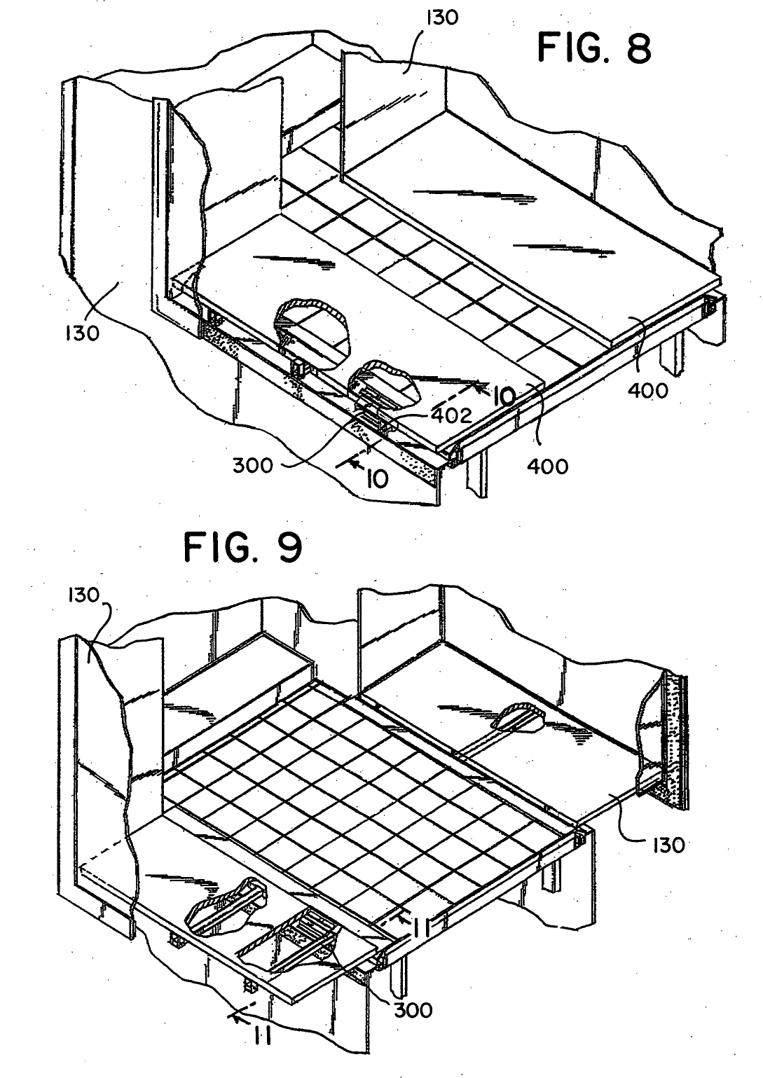

FIG. 8 is a perspective view of the interior space of the RV 100 with the slide-out section 130 in the retracted position, and FIG. 9 is a perspective view of the interior space of the RV 100 with the slide-out section 130 in the extended position. As can be seen, the present slide-out mechanism 300 is of a type that is commonly referred to as an above the floor chassis type mechanism since the slide-out sections 130 are initially disposed above the base floor of the vehicle 100 and mechanism 300 is incorporated into the chassis as opposed to being provided above the base floor. It will be appreciated that while the illustrated slide-out mechanism is of a dual type in that it contains two slide-out sections 130, only a single slide-out section 130 can be provided.

The protruding second ends 352, 362, 372 of the arms 350, 360, 370 are securely coupled to a corresponding movable floor section 400 that represents the floor of the slide-out section 130 and therefore, each slide-out section 130 is driven by urging of its floor portion. The arms 350, 360, 370 can be coupled to the floor section 400 using any number of techniques. For example and according to one embodiment, the arms 350, 360, 370 include openings 354, 364, 374 (shown in FIGS. 4 and 5) on the protruding second ends 352, 362, 372, respectively. A plurality of brackets 402 are provided to couple the second ends 352, 362, 372 to an edge of the floor section 400. The brackets 402 are securely attached to the arms 350, 360, 370 by using fasteners that are received through the openings 354, 364, 374 on the second ends 352, 362, 372 of the arms 350, 360, 370.

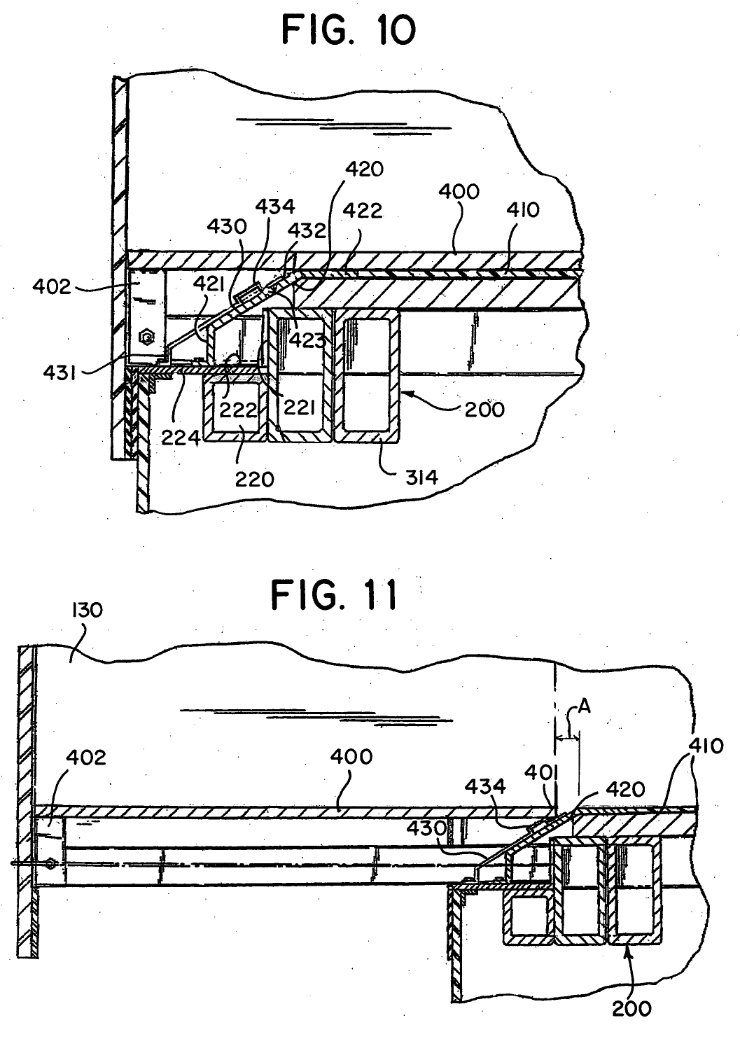

A stationary base floor section 410 is coupled to the chassis 200 and represents a support surface that extends across the chassis 200. The floor section 410 is coupled to the chassis 200 using any number of conventional techniques, including attaching the floor section 410 to the chassis 200 using conventional fasteners, such as screws, nails, etc. The stationary floor section 410 covers the major components of the mechanism 300, e.g., the six support members 320, 330, 340, and is made of a flat, durable flooring material such as plywood or tile. FIG. 10 is a cutaway view taken along the line 10-10 of FIG. 8 of a moveable floor section 400 when the slide-out section 130 is in the retracted position, and FIG. 11 is a cutaway view taken along the line 11-11 of FIG. 9 of the moveable floor section 400 when the slide-out section 130 is in the extended position.

A ledge 220 is formed in the chassis 200 at the left and right sides of the RV 100. The ledge 220 and the chassis 200 itself form a substantially L-shaped face with a vertical surface 221 and a horizontal surface 222. As described above, the chassis 200 includes notches 219 so that the support members 320, 330, 340 are slidably supported therein. The notches 219 allow the arms 350, 360, 370 and a portion of the support members 320, 330, 340 to extend therefrom. In the retracted position, the horizontal surface 222 of the ledge 220 supports the second ends 352, 362, 372 of the arms 350, 360, 370 that protrude outward from the second ends 322, 332, 342 of the support members 320, 330, 340. In the extended position, the horizontal surface 222 of the ledge 220 supports the portion of the arms 350, 360, 370 that overlap thereon. A supporting plate 224 is provided on the vertical surface 221 of the ledge 220 to extend past the sides of the chassis 200. However, alternatively, instead of providing the supporting plate 224, the sides of the chassis 200 can be formed to extend farther than as shown on FIG. 10.

At least one panel 420 covers a portion of the chassis 200 including the ledge 220, a portion of the supporting plate 224, and the top surface of the sides of the chassis 200 that are welded to the side frame members 314. The panel 420 has a vertical surface 421 positioned above the supporting plate 224, a horizontal surface 422 aligned flush with the stationary floor section 410, and a sloped surface 423 joining the vertical and horizontal surfaces 421, 422 of the panel 420. The sloped surface 423 of the panel 420 inclines upward toward the center of the RV 100 so that the horizontal surface 422 of the panel 420 is aligned flush with the stationary floor section 410. The panel 420 thus provides a sloped edge finishing for the floor section 410 and provides a smooth transition to the ledge 220 so that the peripheral edges of the floor section 410 are not exposed.

At least one ramped support 430 is provided proximate to the front support member 320 and the rear support member 340. Preferably, there are two ramped supports 430 that are spaced apart one another to facilitate the sliding action of the slide-out section 130 and to locate the slide-out section 130 when it is extended. The ramped support 430 includes a bottom edge 431 and a top edge 432. The bottom edge 431 of the ramped support 430 is supported by the supporting plate 224, and the top edge 432 of the ramped support 430 overlies the sloped surface 423 of the panel 420.

One moveable floor section 400 is included for each slide-out section 130. Two moveable floor sections 400 are thus included in the illustrated dual slide-out mechanism 300. For sake of brevity and clarity, the following description is directed to the actuation and movements of a single moveable floor section 400. It is understood, however, that this description is equally applicable for the other moveable floor section 400 in a dual slide-out mechanism 300.

The moveable floor section 400 includes one edge attached to the brackets 402 and an opposite edge which is a free edge 401. As described above, the brackets 402 attach the moveable floor section 400 on one side of the RV 100 to the protruding second ends 352, 362, 372 of the three arms 350, 360, 370. Therefore, when the operating mechanism 390 extends and retracts the middle arm 360, the movement of the middle arm 360 is translated to the front and rear arms 350, 370 via the moveable floor section 400, thereby ensuring synchronization of the three arms 350, 360, 370 as they move in and out of the support members 320, 330, 340. In other words, while the middle arms 360 are the only arms that are positively driven, the other arms 350, 370 are passively driven since all of the arms 350, 360, 370 are connected to a common member, namely the floor section 400.

The mechanism 300 of the present invention provides a flush floor between the stationary floor section 410 and the moveable floor sections 400 when the slide-out sections 130 are in the extended positions to provide a nice smooth, transition free enlarged room in the vehicle 100. When the moveable floor section 400 is in the retracted position, it lies on top of the stationary floor section 410. The free edges 401 of the floor sections 400 face another and are in close proximate relation to one another, with a small gap being formed between the free edges 401. After the moveable floor section 400 starts to extend outward via the movement of the arms 350, 360, 370, the free edge 401 of the moveable floor section 400 lowers as it passes over the sloped surface 423 of the panel 420 and the sloped surface of the ramped supports 430. At the extended position, the upper surface of the moveable floor section 400 is aligned essentially flush with the upper surface of the stationary floor section 410, and essentially the entire moveable floor section lies above the brackets 402, the arms 350, 360, 370, the sloped surface 423 of the panel 420, and the sloped surface of the ramped supports 430.

At the extended position, any height differential that exists due to the support of the brackets 402 underneath the moveable floor section 400 is offset by the deflection of the second ends 352, 362, 372 of the arms 350, 360, 370. The weight of the slide-out section 130 on the cantilevered arms 350, 360, 370 allow the moveable floor section 400 to deflect and be substantially horizontal, resulting in the floor sections 400, 410 being substantially flush and planar with one another.

Ramp support 430 can include a feature 434 that serves as a locator or stop that limits the movement of the moveable floor section 400 as it is extended. The feature 434 is preferably an integral feature and represents an elevated section of the ramp support 430 as compared to the surrounding sections. The feature 434 is formed on the beveled section of the ramp support 430. The feature 434 functions as a stop since it limits the degree of travel of the floor section 400 as the floor section 400 travels down the ramp support 430. The illustrated feature 434 represents a bent section of the ramp support 430 that can serve as a catch or stop. The feature 434 is located along the ramp support 430 at a location where the floor section 400 will be flush with the floor section 410 when the floor section 400 seats against the feature 434. In other words, the feature 434 is positioned such that it limits the end of travel of the floor section 400 as the slide-out section 130 is being extended from the base floor section 410.

There may be a slight gap A (shown in FIG. 11) between the end of the moveable floor section 400 and the edge of the sloped sections of the panel 420 and/or the ramped support 430. However, in an embodiment of the present invention, a carpet (not shown) can be used to cover the moveable floor section 400 and the stationary floor section 410, which would also cover this gap. The carpet can be rolled over the moveable floor section 400 and the stationary floor section 410 after the slide-out sections 130 are extended to their extended positions.

When the moveable floor sections 400 are in the process of being retracted, the panel 420 and the ramped support 430 allow the moveable floor sections 400 to slide back up to their original height. At the final retracted position, the moveable floor sections 400 have returned to their original positions overlapping the stationary floor section 410.

In the embodiment shown in FIGS. 1-11, the frame 310 is fixed to the chassis 200 by a known method such as welding. However, in an alternate embodiment of the present invention, the frame 310 is not included. In this alternate embodiment, the support members 320, 330, 340 are fixed directly to the chassis 200. The stubs 318, which are provided on the side frame members 314 in the embodiment shown in FIGS. 1-11, can be provided on the chassis 200 in the alternate embodiment to mate with the first ends 321, 341 of the front and rear support members 320, 340. The middle support members 330 are fixed directly to the chassis 200.

FIG. 12 shows another embodiment of the present invention in which the slide-out mechanism 300 includes a center support sub-assembly 500. The center support sub-assembly 500 is an alternative to the frame 300 and the support members 320, 330, 340 of the embodiment shown in FIGS. 1-11. The exemplary center support sub-assembly 500 has a rectangular shape and is formed of a front member 510, side members 520, and a rear member 530.

The center support sub-assembly 500 is positioned approximately midway between the front and rear sides of the upper deck portion 210 of the chassis 200. One end of the support members 540 is fixed to one of the side members 520, and the other end is slidably supported within notches 522 in the opposite side member 520 and the notches 219 in the chassis 200.

Telescoping arms 550 are slidably supported within the support members 540. The support members 540 and the arms 550 of the center support sub-assembly 500 are substantially identical in size and function to the middle support member 330 and the middle arm 360 of the embodiment shown in FIGS. 1-11. Accordingly, each of the arms 550 is driven by the operating mechanism 390, e.g., hydraulic cylinders 394, and the support members 540 permit access to the arms 500 via longitudinal slots 542 (rectangular slots). Wear tabs 380 can also be included, as shown in FIG. 12, positioned similarly to the embodiment shown in FIGS. 1-11.

Thus, the center support sub-assembly 500 shown in FIG. 12 can be mounted onto the chassis 200 as described above so that there is a single arm 550 that supports each slide-out section 130. The arms 550 include a first end 551, a second end 552, and an opening 554 at the second end 552 for attaching the bracket 402.

In the embodiment described above, the chassis 200 is provided with a single notch 219 on each side of the chassis 200, corresponding to each of the support members 540 of the center support sub-assembly 500.

In another embodiment of the present invention, the chassis 200 can be provided with additional notches 219 to slidably support one or more passive support sub-assemblies 600 so that the center support sub-assembly 500 and the one or more passive support sub-assemblies 600 are spaced apart along the length of the chassis 200. In an exemplary embodiment, two passive support sub-assemblies 600 are provided toward the front and the rear of the upper deck portion 210 of the chassis 200.

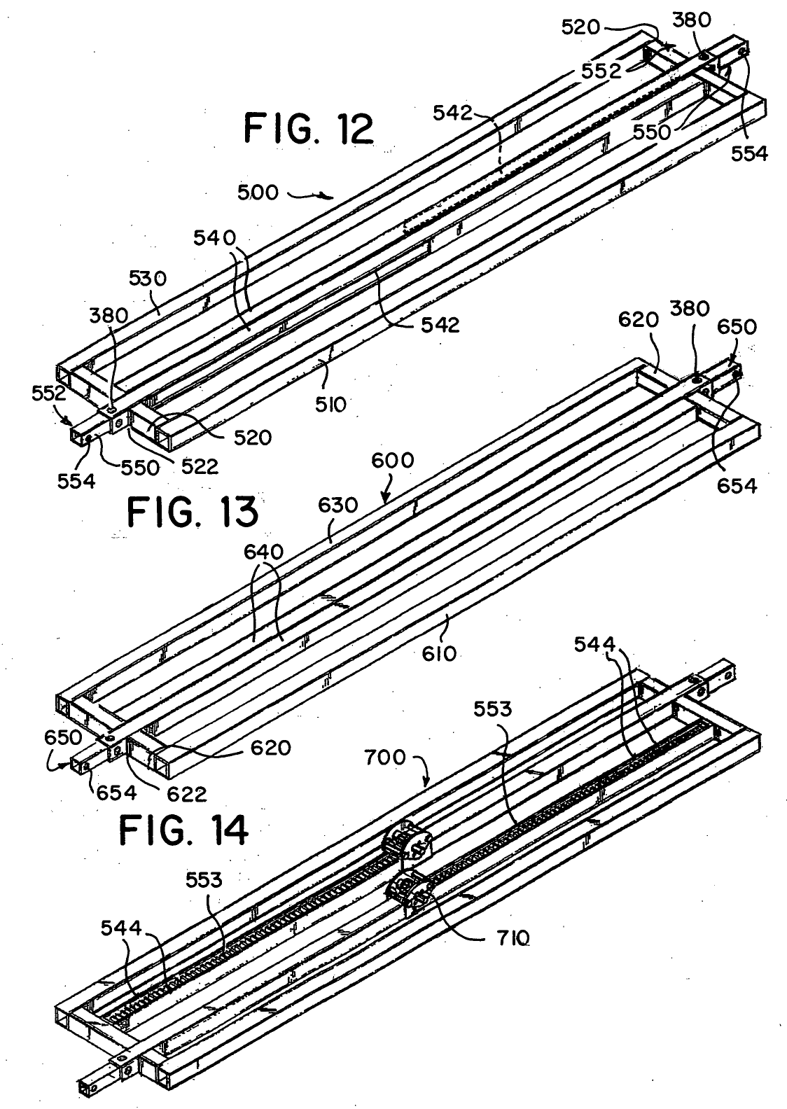

FIG. 13 is a perspective view of the passive support sub-assembly 600 of an alternate embodiment of the present invention. The passive support sub-assembly 600 is similar to the center support sub-assembly 500 except that the passive support sub-assembly 600 is not connected to the operating mechanism 390 and does not include the slot 542. The passive support sub-assembly 600 has a rectangular shape and is formed of a front member 610, side members 620, and a rear member 630. One end of the support members 640 is fixed to one of the side members 620, and the other end is slidably supported within notches 622 in the opposite side member 620 and the notches 219 in the chassis 200.

Telescoping arms 650 are slidably supported in the support members 640 and include an opening 654 for attaching the bracket 402, as described in the embodiment shown in FIGS. 1-11. The arms 650 of the passive support sub-assembly 600 are substantially identical in size and function to the front and rear arms 350, 370 of the embodiment shown in FIGS. 1-11. Wear tabs 380 can also be included, as shown in FIG. 13, positioned similarly to the embodiment shown in FIGS. 1-11.

The embodiments shown in FIGS. 12 and 13 can be used with an operating mechanism 390 in the form of hydraulic cylinders 394. Alternatively, the operating mechanism 390 can include a rack-and-pinion mechanism 700 with a gear mechanism 710 to move the middle arms 550 between the extended and retracted positions.

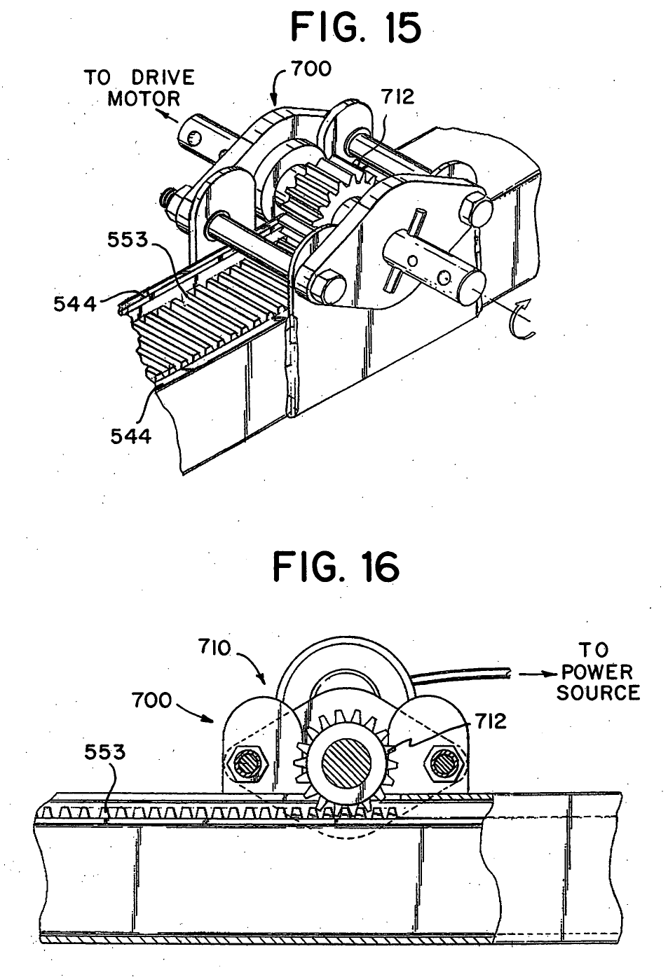

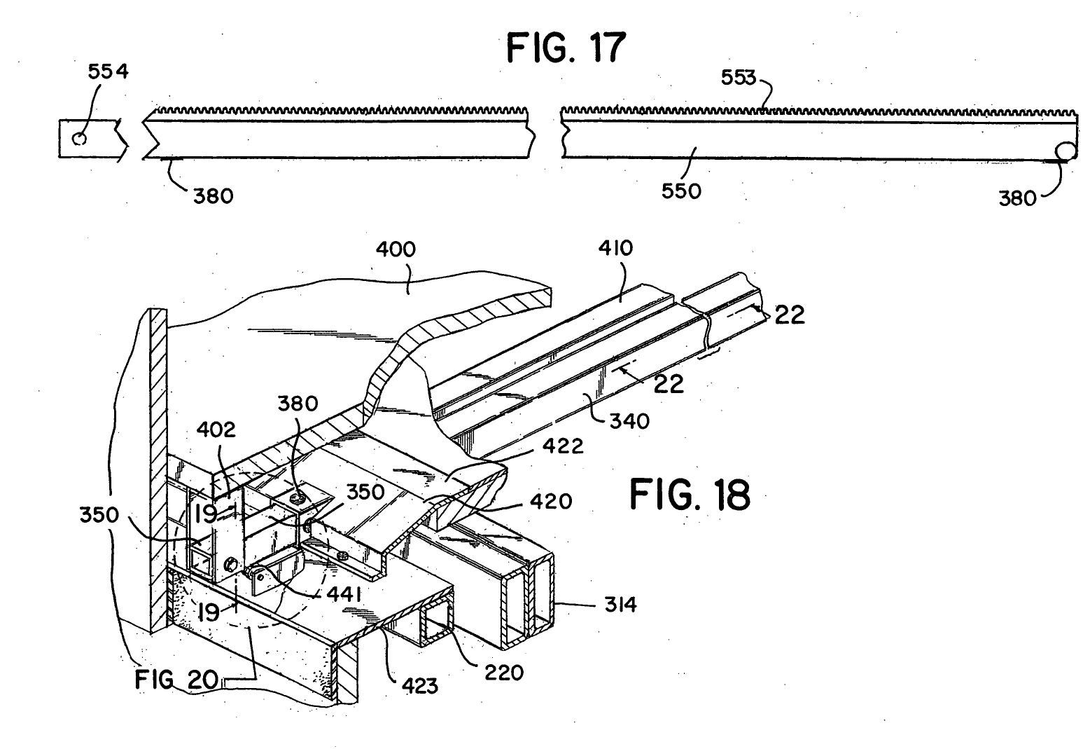

FIG. 14 is a perspective view of the center support sub-assembly 500 and the rack-and-pinion mechanism 700; FIG. 15 is a perspective view of the gear mechanism 710; FIG. 16 is a side view of the center support sub-assembly 500 and the rack-and-pinion mechanism 700 of FIG. 14; and FIG. 17 is a side view of the middle arm 550 and the middle support member 540 of the center support sub-assembly 500 of FIGS. 15 and 16.

Teeth 553 are provided along the top surface of the arms 550 of the center support sub-assembly 500 from the first end 551 to approximately the middle of the arm 550. The teeth 553 mate with a gear 712 of the gear mechanism 710, as shown in FIG. 16.

The support members 540 of the center support sub-assembly 500 of this embodiment are modified so that they have a longitudinal opening at the top surface that extends along a longitudinal length of the support member 540. The opening forms lips 544 that extend over the tops of the arms 550. The lips 544 are short enough to allow the gear mechanism 710 to contact the teeth 553 on the top of the arms 550. It will be appreciated that will the illustrated embodiment shows the longitudinal opening in the top surface extending approximately ½ the length of the support member 540 (e.g., from one end until approximately the location of the gear mechanism), the longitudinal opening can extend the entire length of the support member 540, thereby permitting the teeth 554 of the arm 550 to be disposed above the plane of the lips 544 of the support member 540.

The gear mechanism 710 is fixed in position with respect to the corresponding support member 550 and is driven by a motor (not shown). As the gear 712 in the gear mechanism 710 is rotated in one direction via the motor, the corresponding arm 550 is extended. Accordingly, as the gear 712 in the gear mechanism 710 is rotated in the opposite direction, the corresponding arm 550 is retracted.

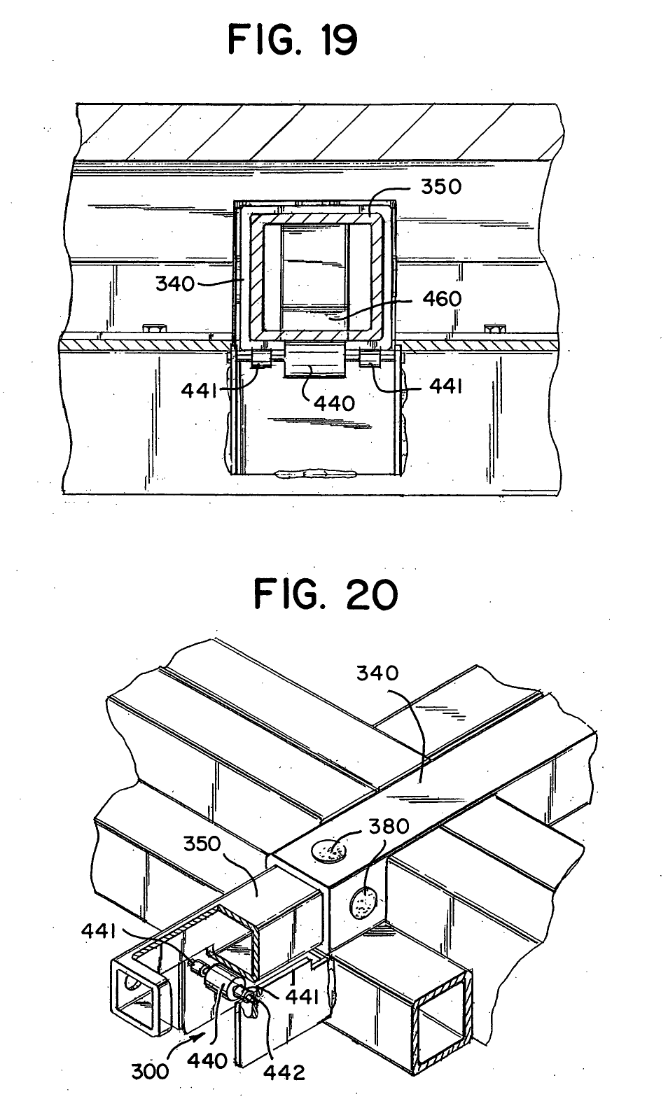

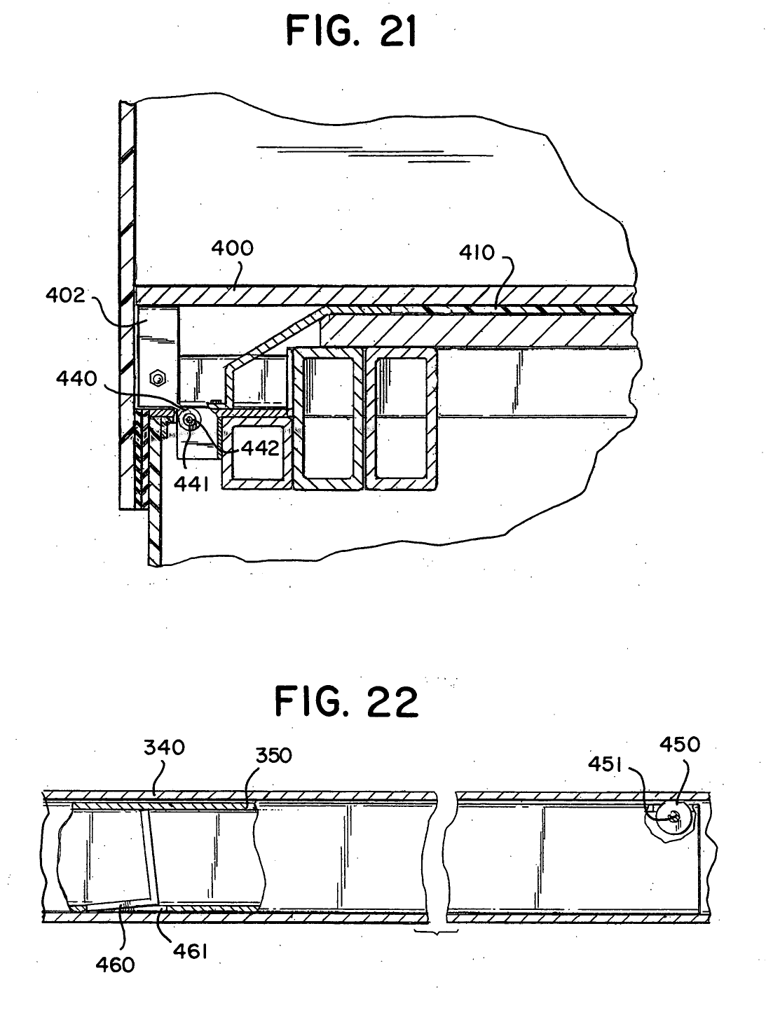

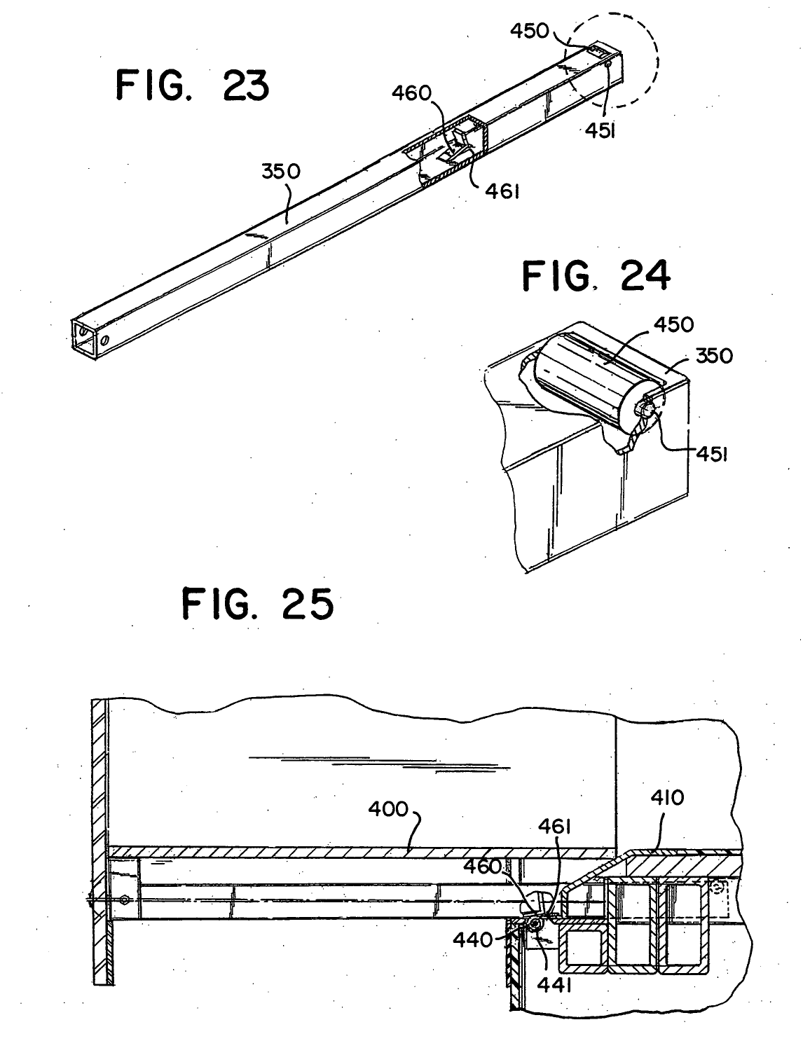

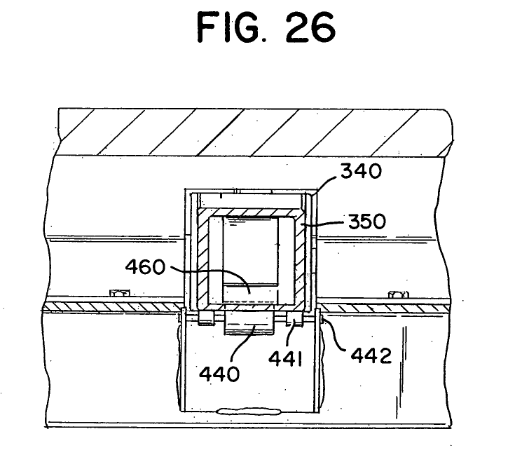

FIGS. 18-26 show another embodiment of the present invention in which the moveable floor section 400 is aligned flush with the stationary floor section 410 as the slide-out section 130 is moved between the retracted and expanded positions without causing the slide-out section 130 to tilt. It will be appreciated that this embodiment shows a means for assisting the movable arm to reach a flush orientation with the floor of the vehicle as the arm is driven to the fully extended position. FIG. 18 shows the environment of the movable arm relative to the chassis frame, etc. It will be appreciated that any of the drive mechanisms disclosed hereinbefore can be used in combination with the illustrated means for lowering the arm to a flush position. For example, the previously described pneumatic and rack and pinion drive systems can be used.

As described above, the support members 320, 330, 340 are relatively stationary with respect to the frame 300 as the arms 350, 360, 370 telescope in and out of the support member 320, 330, 340.

A roller 440 and a pair of smaller-diameter rollers 441 are axially supported by a shaft 442. The shaft 442 is fixed onto a support, e.g., the frame 310, the chassis 200, an extension to the support member 320, 330, 340 (as shown), or some other type of support and is thus fixed stationary relative to the respective support member 320, 330, 340. When the slide-out section 130 is in the retracted position, the second end 352, 362, 372 of the arm 350, 360, 370 is supported by the roller 440, and when the slide-out section 130 moves from the retracted position to the extended position, the roller 440 allows the arm 350, 360, 370 to maintain a level condition when it slides outward within the support member 320, 330, 340. The lower face of the support member 320, 330, 340 can be modified (e.g., as by a cutout) at its distal end so as to accommodate the roller 440 and rollers 441 such that in the extended position, an upper surface of the roller 440 is in contact with and supports the arm 350, 360, 370. The roller 440 and rollers 441 are thus recessed relative to the surrounding lower face of the support member; however, the shaft 440 can still extend through openings formed in side walls of the support member.

Another roller 450 is axially supported by shaft 451, which is fixed onto the top of the arm 350, 360, 370 to allow the top of the arm 350, 360, 370 to contact and roll against the inside of the support member 320, 330, 340 during extension and retraction of the arm 350, 360, 370. This roller is thus directly coupled to the arm and is moveable therewith. It is noted that roller 450 and/or rollers 440/441 can be a side bearing in place of the rollers or any other suitable device.

As described above, the arm 350, 360, 370 is attached via the bracket 402 to the end of the slide-out section 130. As the arm 350, 360, 370 extends out of the support member 320, 330, 340, the arm 350, 360, 370 drives the slide-out section 130 outward in a level manner, i.e., not tipping at an angle relative to the main cabin 120. The movement of the slide-out section 130 occurs in an essentially level, non-tipping manner.

The arm 350, 360, 370 includes an opening 461 (formed on an underside thereof) through which an angled ramp 460 positioned longitudinally toward the center thereof can be accessed. In other words, the ramp 460 is a bent or indented portion of the underside of the arm and leads to the opening 461. The angled ramp 460 is inclined from the underside of the arm 350, 360, 370 upwards to toward the first end 351, 361, 371. The opening 461 in the arm 350, 360, 370 is sized so that the roller 440 can slide therein. The width of the ramp 460 and the opening 461 accommodates the width of the roller 440, with the two rollers 441 being disposed outside of the ramp 460 and opening 461.

When the second end 352, 362, 372 of the arm 350, 360, 370 travels a defined distance out from the support member 320, 330, 340, i.e., when the slide-out section 130 is at a position that it is desired that the slide-out section 130 be lowered, the roller (or bearing pad) 440 falls into the opening 461 in the under side of the arm 350, 360, 370 via the angled ramp 460. When the roller 440 enters the opening 461 in the arm 350, 360, 370, the arm 350, 360, 370 then contacts the smaller diameter rollers (or slide bearings) 441, thusly causing the slide-out section 130 to drop. This drop is preferably timed to occur when the moveable floor section 400 lowers downward from above the stationary floor section 410. The net result is a slide-out section 130 that travels level, without angularity or tilt and at a prescribed distance, lowers in a level manner, i.e., with minimal tipping of the slide-out section 130.

Retraction of the slide-out section 130 occurs in the reverse of the movement described above. As the support member 320, 330, 340 is retracted, the roller (or bearing) 440 moves up through the opening 461 and over the angled ramp 460 in the support member 320, 330, 340, thereby allowing the arm 350, 360, 370 to maintain a level position as the slide-out section 130 is retracted.

Actuation of the above embodiment can be accomplished by the operating mechanism 390 described above, e.g., by a pivoting or trunion mount. For instance, the hydraulic cylinder(s) 394 can be attached to the support member 320, 330, 340 and the arm 350, 360, 370 to drive the arm 350, 360, 370 outward relative to the support member 320, 330, 340. Alternatively, the operating mechanism 390 can include linear actuator(s), e.g., an acme or ball screw with an electric motor input, similarly attached as the hydraulic cylinder 394. In another alternative embodiment, the operating mechanism 390 can include linear actuator(s), e.g., a rack-and-pinion mechanism 700, similarly attached as the hydraulic cylinder 394. In a further embodiment, the operating mechanism 390 drives the shaft 442 of the roller 440 and smaller-diameter rollers 441, and the spinning of the shaft 442 drives the arm 350, 360, 370 outward relative to the support member 320, 330, 340. When the shaft 442 is driven in the opposite direction, the rotation of the rollers 440, 441 causes the arm 350, 360, 370 to be driven in an opposite direction and the slide-out section is retracted inward toward the stationary floor. This embodiment presents a mechanism that smoothly extends and retracts the slide-out section without experiencing any tipping of the slide-out section. Instead, the slide-out section smoothly rides towards and then drops into a location where is substantially flush with the adjacent stationary floor.

The present invention provides a dual slide-out mechanism 300 that spans the width of the RV 100 from the left side to the right side so that the RV 100 can expand on the left and/or right sides. This dual slide-out mechanism 300 includes two slide-out sections 130. The present invention, however, is not limited to a dual slide-out mechanism 300 and can be mounted as a single slide-out mechanism in either the left or right side of the RV 100, thereby providing one slide-out section.

Preferably, the inward length of the side walls 134 of the slide-out section 130 defines the limit of expansion of the slide-out section 130. In an embodiment of the present invention, the slide-out section 130 may be occupied when in the retracted position, and a balance is achieved by making the inward length as large as it can be without unduly interfering with the use of the RV 100 interior during transit. Typically, the upper deck portion of the RV 100 is used as a living room or seating area; and, therefore, the slide-out section 130 can be incorporated into the living room area of the upper deck portion of the RV 100 as a means for increasing the interior living space. Furniture, such as a chair and/or an entertainment center, can be fixed to one or both of the moveable floor sections 400 to slide out with the slide-out section 130, thereby increasing the amount of available space toward the center of the RV 100.

As can be seen in the foregoing description and drawings, the dual slide-out mechanism 300 can be constructed as a single slide-out mechanism for incorporating a single slide-out section 130 in the left or right side of the RV 100. A single slide-out mechanism includes a single set of support members, which includes one front support member 320, one middle support member 330, and one rear support member 340, and a single set of arms, which includes one front arm 350, one middle arm 360, and one rear arm 370.

The following example is intended to illustrate the construction and the advantages of the present invention more fully without limiting its scope, since numerous modifications and variations will be apparent to those skilled in the art.

### EXAMPLE

In one example of the present invention, the frame 310 is constructed to have a length of 76″ from the front surface of the front frame member 312 to the rear surface of the rear frame member 316 and 84″ wide from the outward facing surfaces of the side frame members 314. The support members 320, 330, 340 and arms 350, 360, 370 have a square-shaped cross section. The outer dimensions of the support members 320, 330, 340 are approximately 2″×2″, and the outer dimensions of the arms 350, 360, 370 are approximately 1½″×1½″. The middle support members 330 are separated from the front and rear support members 320, 340 by approximately 30″-32″.

Openings (not shown) for mounting the plate 366 in one wall of the middle arm 360 are positioned approximately 39¼″ in the longitudinal direction from the second end 362 of the middle arm 360 that attaches to the brackets 402. These holes are aligned with the openings (not shown) in the plate 366 for mounting the shaft 392 of the hydraulic cylinder 394.

In the extended state, the second ends 352, 362, 372 of the arms 350, 360, 370 are extended approximately 24″-36″ between the extended and retracted states, and the slots 336 in the middle support members 330 are approximately 36″ long.

It will be appreciated that the present invention can either be embodied as a single slide-out section or a dual slide-out section since it may be desirable to provide only a single slide-out section. The mechanism of the present invention advantageously permits the vehicle to either include a single or plural slide-out sections that are operated via the present mechanism.

Another advantage of the present invention is that the drive mechanism and timing mechanism are orientated in such a manner that they are shielded from the elements outside of the vehicle since neither of these mechanisms ever leaves the vehicle itself during operation thereof and retraction and extension of the slide-out section. In other words, since the mechanisms are contained in the vehicle during operation, they are never effected by weather, etc., unlike conventional constructions where the drive mechanism was exposed to weather when the slide-out section was moved to the extended position.

Having described embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A slide-out mechanism for a vehicle for extending and retracting a first slide-out section relative to a frame of the vehicle that includes spaced locating features, comprising:
a slide-out frame including a plurality of support members with at least one support member being a hollow support member; wherein the slide-out frame includes coupling features that removably mate with the spaced locating features of the vehicle frame so as to position and substantially lock the frame in a front-rear and side-to-side manner relative to the vehicle frame;
at least one first driven arm slidably received in the hollow support member, the first arm having a distal end securely attached to the first slide-out section; and
a first drive means operably coupled to one first arm for controllably driving the first arm in a first direction for extending the arm outwardly from the slide-out frame resulting in the first slide-out section being driven to an extended position and in a second direction for retracting the first arm toward the slide-out frame resulting in the first slide-out section being driven to a retracted position.

2. The slide-out mechanism of claim 1, wherein the spaced locating features comprise notches formed in opposing side support rails of the frame and the coupling features comprise a protruding length of the support member that extends beyond side rails of the slide-out frame, the protruding length of the support member being intimately received within one notch formed in the side rails of the vehicle frame.

3. The slide-out mechanism of claim 1, wherein the slide-out frame is formed of a pair of side rails, a pair of end rails attached at their ends to ends of the side rails, each side rail having notches formed therein for receiving and securely holding one end of one support member.

4. The slide-out mechanism of claim 3, wherein adjacent support members that form one pair are received in notches that are formed in opposite side rails.

5. The slide-out mechanism of claim 3, wherein the spaced locating features comprise notches formed in opposing side support rails of the frame and wherein the notches formed in the side rails of the slide-out frame are axially aligned with the notches formed in the side support rails of the vehicle frame.

6. The slide-out mechanism of claim 1, wherein the first drive means is coupled to the hollow support member and includes a drive shaft that is securely attached to the first driven arm through a window formed in the hollow support member.

7. The slide-out mechanism of claim 6, wherein the window defines a length of travel of the first driven arm.

8. The slide-out mechanism of claim 1, wherein the first drive means is a pneumatically based drive system.

9. The slide-out mechanism of claim 6, wherein the first drive means includes a pneumatic drive cylinder that is operably connected to an air source for controllably driving the drive shaft in the first and second directions.

10. The slide-out mechanism of claim 1, wherein the support members include a plurality of hollow support members that receive passive drive arms that are securely attached at their distal ends to the first slide-out section, the passive drive arm being free of operable attachment to the first drive means.

11. The slide-out mechanism of claim 10, wherein the first drive arm is disposed in a central location of the slide-out frame with one passive arm being disposed at a forward section of the slide-out frame and another passive arm being disposed at a rear section of the slide-out frame.

12. The slide-out mechanism of claim 1, further including:
a second slide-out section that moves outwardly from an opposite side of the slide-out frame compared to the first slide-out section; and
wherein the slide-out mechanism includes:
at least one second driven arm slidably received in one hollow support member, the second arm having a distal end securely attached to the second slide-out section; and
a second drive means operably coupled to the second arm for controllably driving the second arm in a first direction for extending the arm outwardly from the slide-out frame resulting in the second slide-out section being driven to an extended position and in a second direction for retracting the second arm toward the slide-out frame resulting in the second slide-out section being driven to a retracted position.

13. The slide-out mechanism of claim 12, wherein the first drive means is coupled to one hollow support member and includes a drive shaft that is securely attached to the first driven arm through a window formed in the hollow support member and wherein the second drive means is operably coupled to the second arm through a window formed in another hollow support member that receives the second arm, wherein the windows that receive the first and second drive means, respectively, are parallel one another.

14. The slide-out mechanism of claim 13, wherein the first and second drive means are coupled to adjacent hollow support members that contain the first and second driven arms

15. The slide-out mechanism of claim 1, wherein the first slide-out section rides on top of a stationary floor that is attached to the vehicle frame, the slide-out mechanism including a ramp formed at an outer edge of the stationary floor and being positioned to cause the first slide-out section to be lowered in a substantially level manner as it is driven to the extended position and brought into a substantially flush relationship with the stationary floor.

16. The slide-out mechanism of claim 15, further including a stop formed as part of the ramp to limit the travel of the first slide-out section in the first direction.

17. The slide-out mechanism of claim 16, wherein the stop comprises a bent section formed along a beveled surface of the ramp which contacts an inner edge of the slide-out section to stop the further movement of the slide-out section in the first direction.

18. The slide-out mechanism of claim 1, wherein the first drive means comprises a rack and pinion mechanism including a first gear mechanism coupled to the hollow support member that receives the first driven arm, the first gear mechanism meshingly mating with a rack formed as part of the first driven arm and being accessible through a longitudinal slot formed in the hollow support member.

19. The slide-out mechanism of claim 18, wherein the first gear mechanism is mounted stationary relative to the hollow support member receiving the first driven arm.

20. The slide-out mechanism of claim 18, wherein the first gear mechanism is operably coupled to a drive motor via a drive shaft for controllably rotating the first gear mechanism in a first direction for driving the first driven arm in the first direction and in a second direction for driving the first driven arm in the second direction

21. The slide-out mechanism of claim 18, further including a second drive means comprising a rack and pinion mechanism including a second gear mechanism coupled to the hollow support member that receives the second driven arm, the second gear mechanism meshingly mating with a rack formed as part of the second driven arm and being accessible through a longitudinal slot formed in the hollow support member.

22. The slide-out mechanism of claim 18, wherein the first gear mechanism is operably coupled to a drive motor via a drive shaft for controllably rotating the first gear mechanism in a first direction for driving the first driven arm in the first direction and in a second direction for driving the first driven arm in the second direction

23. The slide-out mechanism of claim 21, wherein the first and second gear mechanism are driven independent from one another.

24. The slide-out mechanism of claim 21, wherein the first and second gear mechanism are provided on hollow support members that are adjacent one another with the first direction of the first drive arm being opposite the first direction of the second drive arm.

25. The slide-out mechanism of claim 18, wherein the longitudinal slot is formed in an upper face of the hollow support member and is defined between two inward lips of the hollow support member

26. The slide-out mechanism of claim 18, wherein the gear mechanism includes two air lines fluidly connected to an air cylinder where delivery of air through one of the air lines causes the first driven arm to move in the first direction and delivery of air through the other of the air lines causes the first driven arm to move in the opposite second direction.

27. The slide-out mechanism of claim 1, wherein the slide-out frame is coupled to the vehicle frame such that the slide-out frame is movable in an up and down manner relative to the vehicle frame.

28. The slide-out mechanism of claim 18, wherein the gear mechanism is disposed between the slide-out frame and a stationary floor of the vehicle frame.

29. A slide-out mechanism for a vehicle for extending and retracting first and second slide-out sections relative to a frame of the vehicle that includes a stationary floor, comprising:
a slide-out frame including a plurality of support members with at least one support member being a hollow support member;
at least one first driven arm slidably received in one hollow support member, the first arm having a distal end securely attached to the first slide-out section;
a first drive means operably coupled to one first arm for controllably driving the first arm in a first direction for extending the arm outwardly from the slide-out frame resulting in the first slide-out section being driven across the stationary floor to an extended position and in a second direction for retracting the first arm toward the slide-out frame resulting in the first slide-out section being driven to a retracted position; and
means for causing the slide-out section to be lowered in a substantially level manner and brought into a substantially flush relationship with the stationary floor that is supported on the vehicle frame, the means including a first element that is fixed and stationary relative to the movable arm and a second element that is integral to the movable arm.

30. The slide-out mechanism of claim 29, further including:
at least one second driven arm slidably received in another hollow support member, the second arm having a distal end securely attached to the second slide-out section; and
a second drive means operably coupled to the second arm for controllably driving the second arm in a first direction for extending the arm outwardly from the slide-out frame resulting in the second slide-out section being driven to an extended position and in a second direction for retracting the second arm toward the slide-out frame resulting in the second slide-out section being driven to a retracted position, wherein the first and second drive means are independently operable relative to one another to cause independent extension and retraction of one of the first and second slide-out sections.

31. The slide-out mechanism of claim 29, wherein the first drive means comprises a pneumatic drive system or a rack and pinion drive system.

32. The slide-out mechanism of claim 29, wherein the first element of the means for lowering the slide-out section comprises:
a first roller disposed between a pair of second rollers that are rotatably aligned the same axis, the first roller having a diameter greater than the diameter of the second rollers such that prior to the slide-out section reaching the extended position, the movable arm rides along the first roller until the first roller rides encounters the second element which is in the form of an angled ramp and rides into a slot formed on an underside of the movable arm so as to cause the slide-out section to drop into a flush arrangement with the stationary floor, while being supported on the second rollers.

33. The slide-out mechanism of claim 32, wherein the ramp comprises an inwardly bent section of a bottom floor of the movable arm.

34. The slide-out mechanism of claim 30, wherein a floor of the slide-out section rides along the stationary floor associated with the vehicle until the first element encounters and interacts with the second element to cause a lowering of the slide-out section into the flush arrangement.

35. A slide-out mechanism for a vehicle for extending and retracting at least one slide-out section relative to a frame of the vehicle, the slide-out section having a floor and the slide-out mechanism being configured for incorporation into a chassis in the vehicle and comprises:
a frame comprising at least one hollow support member and a rotatable member disposed at one end of the at least one support member and having a first rotatable element and a second rotatable element;
at least one movable arm slidably received in the at least one support member, the at least one movable arm having an end that is securely coupled to the floor of the slide-out section, wherein one face of the at least one movable arm includes a ramped portion indented inwardly and leading to a slot formed at one end of the ramped portion;
drive means coupled to the at least one arm for driving the arm in a first direction for extending the arm outwardly from the frame resulting in the slide-out section being driven to an extended position and a second direction for retracting the arm toward the frame resulting in the slide-out section being driven to a retracted position; and
wherein as the slide-out section is driven in the first direction, the one face of the arm contacts the first rotatable element and is driven thereover until after the arm has moved in the first direction a predetermined distance, the first rotatable element rides along the ramped portion and enters the slot, while the second rotatable element is brought into contact with and supports the one face of the arm for causing the slide-out section to be lowered in a substantially level manner and brought into a substantially flush relationship with a stationary floor supported on the chassis.

36. The slide-out mechanism of claim 35, wherein the first rotatable element is a roller having a first diameter and the second rotatable element is a roller having a second diameter, the first and second rotatable elements being supported by a common drive shaft that is fixed to one of the frame and the chassis.

37. The slide-out mechanism of claim 35, wherein the ramped portion and slot are formed on an underside of the movable arm.

38. The slide-out mechanism of claim 35, further including a third rotatable element coupled to a top surface of the movable arm for contacting and riding along an inner surface of the hollow support member.

39. The slide-out mechanism of claim 35, wherein the first and second rotatable elements are disposed at an edge of the chassis.
